(19) United States
(12) Patent Application Publication
(10) Pub. No.: US 2010/0253565 A1
(43) Pub. Date: Oct. 7, 2010

(54) Method and apparatus to increase ADS-B squitter reception sensitivity

(76) Inventor: Gregory H. Piesinger, Cave Creek, AZ (US)

Correspondence Address: SQUIRE SANDERS & DEMPSEY LLP, 1 East Washington Street, SUITE 2700, PHOENIX, AZ, 85004, US

(21) Appl. No.: 11/784,235

(22) Filed: Apr. 6, 2007

Related U.S. Application Data
(60) Provisional application No. 60/790,927, filed on Apr. 10, 2006.

(51) Int. Cl. G01S 13/93; G01S 13/74

(52) U.S. Cl. 342/29

(57) ABSTRACT

A TCAS receiver includes an antenna, an analog to digital converter (ADC), and a FPGA. The antenna receives an ADS-B squitter signal. The ADC converts the signal to a digital signal. The FPGA uses matched filters for matching at least a portion of the digital signal to a message, thereby increasing ADS-B squitter sensitivity.

### PRIORITY REFERENCE TO PRIOR APPLICATIONS

This application claims benefit of and incorporates by reference U.S. patent application Ser. No. 60/790,927, entitled “METHOD AND APPARATUS TO INCREASE ADS-B SQUITTER RECEPTION SENSITIVITY,” filed on Apr. 10, 2006, by inventor Gregory H. Piesinger.

### TECHNICAL FIELD

This invention relates generally to avionics, and more particularly, but not exclusively, provides an apparatus and method for increased ADS-B squitter reception sensitivity.

### BACKGROUND

Appendices I and M of Radio Technical Commission for Aeronautics (RTCA) DO-260A describes various techniques that can be used to increase the reception sensitivity of Automatic Dependent Surveillance-Broadcast (ADS-B) or Traffic Information Service-Broadcast (TIS-B) squitter messages. ADS-B or TIS-B messages are 112 bit pulse position modulation (PPM) messages preceded by a four pulse preamble. The first 5 bits of the message is the downlink field (DF). An ADS-B message has a DF field equal to 17 decimal (10001 binary), and a TIS-B message has a DF field equal to 18 decimal (10010 binary).

The standard Traffic Collision Avoidance System (TCAS) receiver sensitivity requirement per RTCA DO-185A is −72 dBm (at the antenna end of the transmission line). At this RF level, a minimum of 90% of Mode S replies must be decoded. RTCA DO-260A (1090 MHz ADS-B MOPS) defines multiple categories for receiver sensitivity. DO-260A category A0 has the same sensitivity requirements as TCAS (−72 dBm for ADS-B messages), categories A1 and A2 are 7 dB more sensitive than TCAS (−79 dBm), and category A3 is 12 dB more sensitive than TCAS (−84 dBm). A 12 dB sensitivity improvement provides a factor of four improvement in reception range. A number of ADS-B/TIS-B applications require the longer reception ranges.

Although written in 2003, DO-260A Appendix I is primarily based on techniques dating back to 1984. Some of these techniques were included in the original TCAS requirements document (DO-185). In the 80's, the processing power of microprocessors and Digital Signal Processors (DSPs) were minimal by today's standards. Therefore, the techniques described in appendix I were based on simple pulse sampling techniques.

DO-260A Appendix I techniques primarily discuss the improvement in techniques for sampling and decoding ADS-B/TIS-B messages. Appendix M describes requirements which primarily affect the hardware design of the system in order to improve receiver sensitivity. This includes the use of an active antenna in order to provide the sensitivity required for category A3. For an existing TCAS system, this would require the addition of a 3^{rd} antenna along with the required internal receiver and processing hardware. The addition of an active antenna for TCAS will provide a sensitivity improvement of approximately 5 dB, by eliminating losses prior to the first amplifier in the receiver. These losses include the antenna to unit transmission line (3 dB), and internal TCAS losses due to filters and transmit/receive switching circuitry (approximately 2 dB).

An example of this is shown in FIG. 1 and FIG. 2. FIG. 1 is receiver video data obtained from the WJ Hughes FAA Technical Center for an ADS-B preamble pulse at −84 dBm (A3 Receiver Sensitivity Minimum Trigger Level—MTL). The data was taken using an ADS-B receive only system which would have an active antenna. The figure shows that the pulses have a signal level which is approximately 7 dB above tangential sensitivity (bottom of the pulse to the top of the noise). The MOPS methods in DO-260A were derived assuming the use of a receiver which has pulses of this fidelity. However, FIG. 2 shows the same data obtained from a TCAS receiver. In this case, the pulse only has a signal level which is 2 dB above tangential sensitivity, and is approximately 5 dB worse than the FAA data. The MOPS methods do not work well with pulses which have this poor of a signal quality.

As such, a new apparatus and method are needed for improving ADS-B squitter sensitivity.

### SUMMARY

Using a modern Field Programmable Gate Array (FPGA), much more sophisticated techniques can be economically implemented. One such technique is to implement the receiver as a filter matched to the known time or spectral response of the transmitted message.

Previous attempts to increase ADS-B squitter sensitivity were based on increasing the sampling rate of the detected pulses and using empirical techniques to ascertain if a pulse was a “1” or a “0”. These techniques can never provide the sensitivity obtainable by matched filters because wide bandwidths are required to obtain good pulse fidelity, and wide bandwidths increase noise. In contrast, the bandwidth of matched filters are matched to the bandwidth of the signal, which minimize noise.

In an embodiment of the invention a TCAS receiver includes an antenna, an analog to digital converter (ADC), and a FPGA. The antenna receives an ADS-B squitter or TIS-B squitter signal. The ADC converts the signal to a digital signal. The FPGA uses matched filters for matching at least a portion of the digital signal to a message, thereby increasing ADS-B squitter sensitivity.

In an embodiment of the invention, a method comprises: receiving an ADS-B or TIS-B squitter signal; converting the signal to a digital signal; and matching at least a portion of the digital signal to a message using matched filters.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a graph illustrating Federal Aviation Administration (FAA) Tech Center video data for an ADS-B preamble pulse at −84 dBm;

FIG. 2 is a graph illustrating the same data as FIG. 1, but obtained from a TCAS 3000 receiver;

FIG. 3 is a block diagram illustrating a TCAS receiver according to an embodiment of the invention;

FIG. 4 is a block diagram illustrating a matched filter field programmable gate array (FPGA) of the TCAS receiver;

FIG. 5 is a flowchart illustrating a Matched Filter Preamble Detection Logic; and

FIG. 6 is a flowchart illustrating a Matched Filter Preamble Timing Logic.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

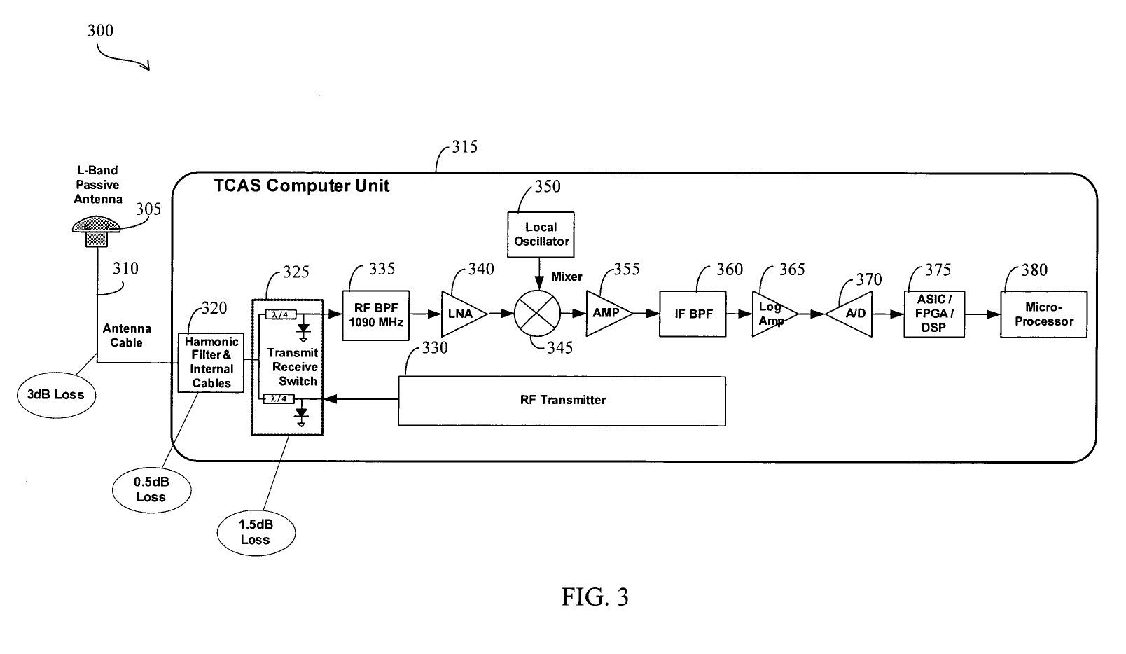

FIG. 3 is a block diagram illustrating a TCAS receiver 300 according to an embodiment of the invention. Although a matched filter can be implemented in either the frequency domain or the time domain, a time domain implementation is most applicable for the TCAS receiver 300. A passive L-Band antenna 305 (either directional or omni-directional) is connected to the TCAS unit 315 through an RF cable 310 with a loss of up to 3 dB. When TCAS is in the receive mode, the TCAS receiver 300 processes both 1090 MHz reply signals and squitter signals for both TCAS and ADS-B functions. Coupled to the antenna cable 310 are harmonic filter and internal cables 320 and a transmit/receive switch 325. A 1090 MHz band-pass filter (BPF) 335 is coupled to the switch 325 and used to provide rejection of out of band signals prior to a first Low Noise Amplifier (LNA) 340. The signal is amplified by an amp 340. The amplified signal is down-converted to an intermediate frequency (IF) by using local oscillator 350 and mixer 345. The IF is amplified using amplifier (AMP) 355 and filtered using IF BPF 360. The IF filter 360 sets the final receiver bandwidth. The filtered IF signal is input to a Logarithmic Amplifier/Detector 365 which generates the receiver video base-band signal. The video signal is input to an Analog to Digital converter 370 which outputs the quantized data samples to a Field Programmable Gate Array (FPGA) device 375. The FPGA 375 performs all the digital sampling and detection algorithms, including those described in DO-185A and DO-260A. A micro-processor 380, coupled to the FPGA 375, processes TCAS and ADS-B receiver data and performs the surveillance and collision avoidance functions.

Using this invention, digitized pulses will be processed in the FPGA 375 using matched filter techniques. In an embodiment of the invention, the FPGA 375 can include or be replaced with an application specific integrated circuit and/or a digital signal processor. For ease of explanation, the term FPGA 375 includes these alternatives throughout this document.

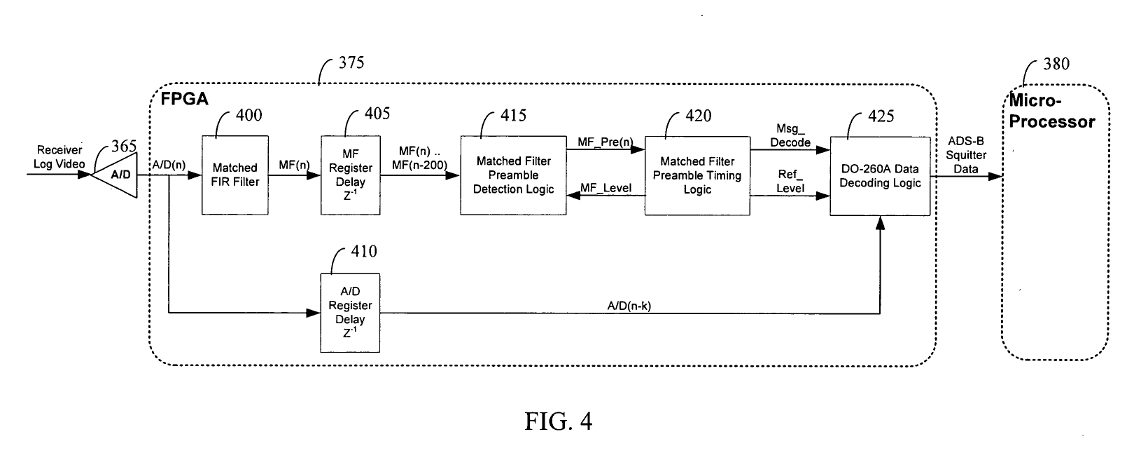

FIG. 4 is a block diagram illustrating a matched filter FPGA 375 of the TCAS receiver 300 for a single antenna channel. A Matched Filter method is used for the detection of ADS-B/TIS-B preambles, in conjunction with using the DO-260A MOPS or some other method for the decoding of the data in the ADS-B/TIS-B squitter. An embodiment of the invention uses the Matched Filter for preamble detection along with the DO-260A Base-Line multi-sample method as described in DO-260A Appendix 1.4.2.3.1.

Embodiments of the invention are implemented as part of the Field Programmable Gate Array which is contained in the TCAS receiver 300 (e.g., an ACSS TCAS 3000). For each A/D sample, each of the blocks process the data input to each block, and provide the outputs from each block which is input to the next block. The FPGA 375 includes a matched FIR filter 400 coupled to a MF register delay 405, which is coupled to a matched filter preamble detection logic block 415, which is coupled to a matched filter preamble timing logic block 420, which is coupled to a DO-260A Data Decoding logic block 425, which is coupled to the microprocessor 380. An A/D register delay block 410 is also coupled to the DO-260A Data Decoding Logic Block 425 and the ADC 370 (Note: change A/D 365 to 370 in FIG. 4).

The A/D converter 370 samples the receiver's 300 log video at a 16 MSPS data rate (Fs). The data samples have an 8 bit resolution, with a bit value of approximately 0.289 dB/bit (unsigned integer). The A/D data offset is set to approximately −92 dBm, so a A/D value of 0 decimal corresponds to a receiver signal of −92 dBm, and a value of 255 decimal corresponds to a receiver signal of −18.3 dBm.

The FPGA 375 shows a single A/D 370, which would be representative of using an embodiment of the invention with an omni-directional antenna. If a Directional Antenna is used (in the case of the TCAS Top aircraft antenna), there are 4 A/D converters, one for each antenna port. An ACSS TCAS directional antenna is an amplitude mono-pulse design, where the amplitude on each of the 4 antenna ports is a function of the bearing of the received signal. A number of different applications are possible for the use of the invention with this configuration. One embodiment is to compare the 4 A/D converter samples on a sample by sample basis and input the sample with the greatest magnitude into the Matched FIR Filter 400. This saves the most space within the FPGA 375. However a number of different embodiments are possible with this invention which would provide improved performance at the cost of additional resources. Other possible embodiments would be having 4 independent ADS-B FPGA paths, with each path as shown in FIG. 4, where the Micro-Processor 380 would receive data for all 4 channels, and would sort out duplicate data. Another embodiment includes having 4 independent Matched FIR Filters 400, and select the largest amplitude output on a sample by sample basis as an input to a MF Register Delay Block 405. There are many more permutations of possible embodiments which could be realized with this invention.

The Matched FIR Filter 400 is an 8 tap Finite Impulse Response (FIR) filter whose coefficients are matched to the approximate pulse shape of the receiver video. The filter has the following form:

MF(n)=b0*A/D(n)+b1*A/D(n−1)+b2*A/D(n−2)+b3*A/D(n−3)+b4*A/D(n−4)+b5*A/D(n−5)+b6*A/D(n−6)+b7*A/D(n−7)

The coefficients b0 to b7 are matched to the approximate shape of the receiver log video for a pulse which is 500 nano-seconds in width. The coefficient values used in an embodiment of the invention are [0.5 1 1 1 1 1 1 0.5]. However in order to provide a filter output which is normalized to the level of the A/D input, the coefficients would be divided by a constant of 6.25. For the purpose of the description of this invention, it is assumed that this normalization occurs in the Matched FIR Filter 400. Note that this normalization could be done at other points in the FPGA 375, prior to a DO-260A Data Decoding Logic Block 425. Alternately the A/D samples which pass through the A/D register delay block 410 could be multiplied by 6.25 prior to the DO-260A Data Decoding Logic Block 425 in order to provide the equivalent functionality.

The MF Register Delay Block 405 provides delayed versions of the Matched Filter outputs MF(n), which are input to the Matched Filter Preamble Detection Logic Block 415. The block 405 requires a minimum of 201 taps (n to n−200). At a 16 MHz sample rate this provides 12.5 micro-seconds of matched filter samples which allows for the algorithm to detect the presence of 4 preamble pulses along with the first 5 bits of the ADS-B message (termed Downlink Format Field, DF).

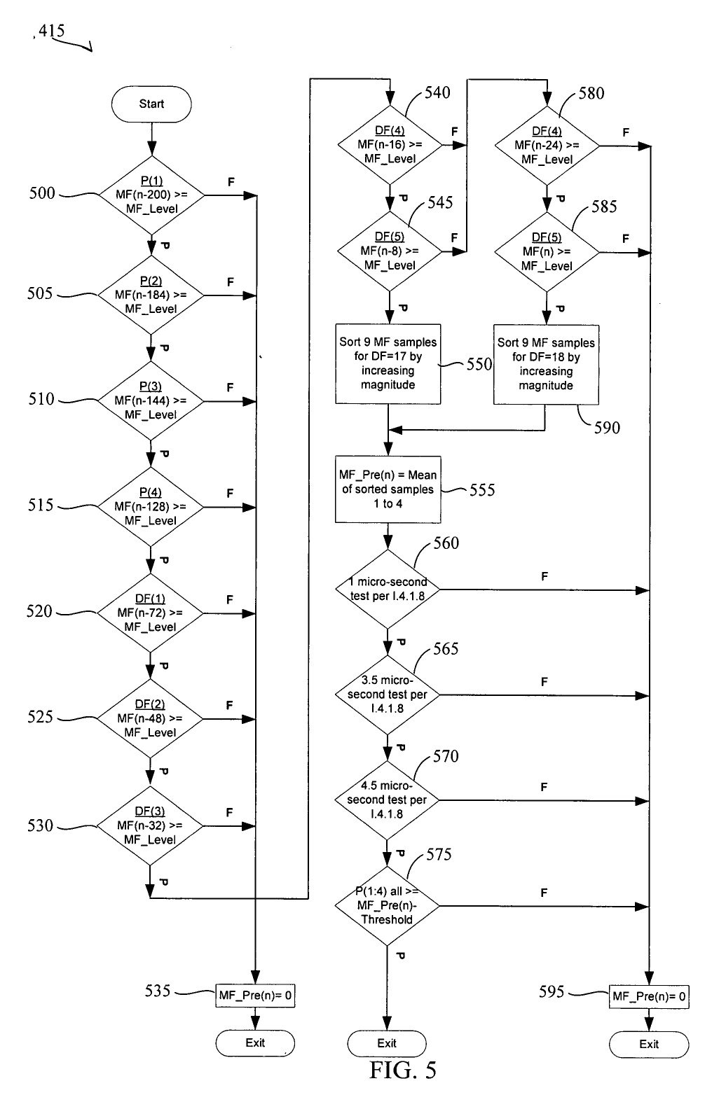

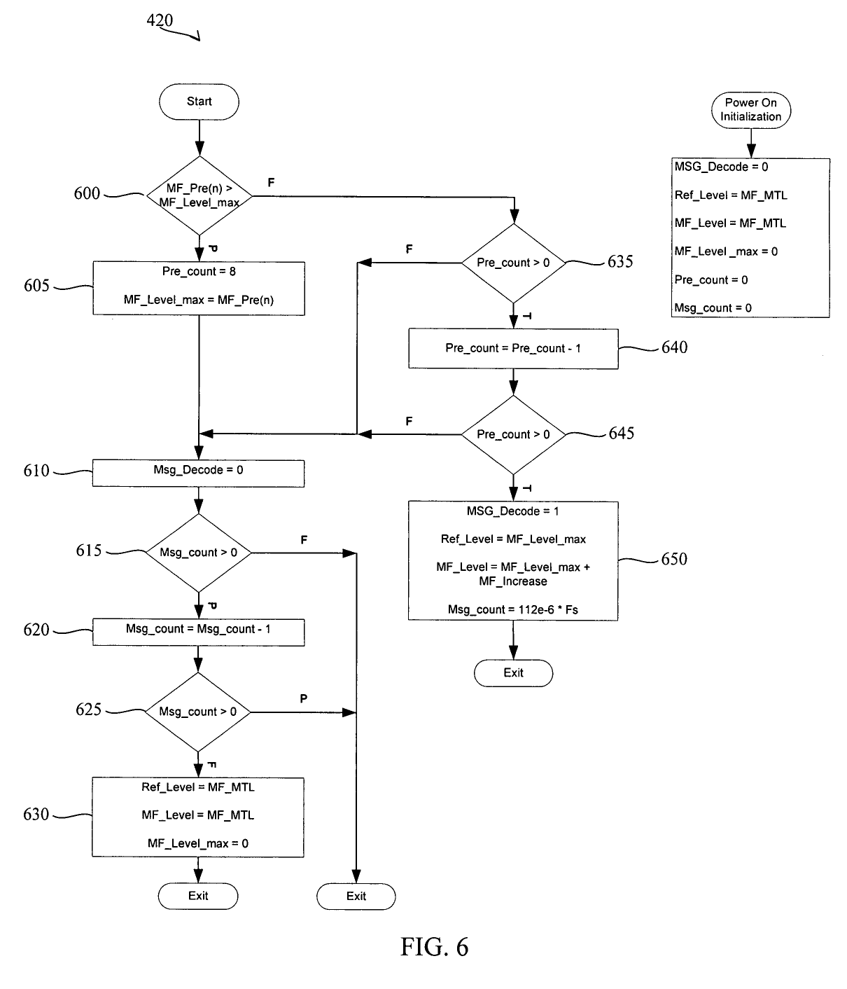

The Matched Filter Preamble Detection Logic Block 415 is used to detect the presence of a valid ADS-B/TIS-B preamble and will be discussed in further detail below in conjunction with FIG. 5. The Matched Filter Preamble Timing Logic Block 420 is used to detect the position of a valid preamble and controls the reference level which is used for decoding the data and will be discussed in further detail below in conjunction with FIG. 6.

The A/D Register Delay block 410 delays the A/D sample in order to allow for the DO-260A Data Decoding Logic Block 425 to synchronize the data stream with the start of the data field in the ADS-B message. Since the Matched Filter Preamble Detection and Preamble Timing Logic Blocks 415 and 420 wait until the first 5 data bits of the ADS-B message are received, the A/D samples must be delayed by 5 bits (5*16=80 samples) plus any additional pipeline delay within these preamble detection blocks. The data is delayed so that when the Msg_Decode signal is set to a 1, the A/D data sample which is processed by the DO-260A Data Decoding Logic Block 425 is the start of the first bit in the ADS-B/TIS-B message.

The DO-260A Data Decoding Logic Block 425 processes the data according to the DO-260A MOPS for Enhanced Bit and Confidence Declaration in Appendix 1.4.2. This algorithm is well known and is documented in DO-260A Appendix I. However other algorithms for data detection and error detection or correction are possible.

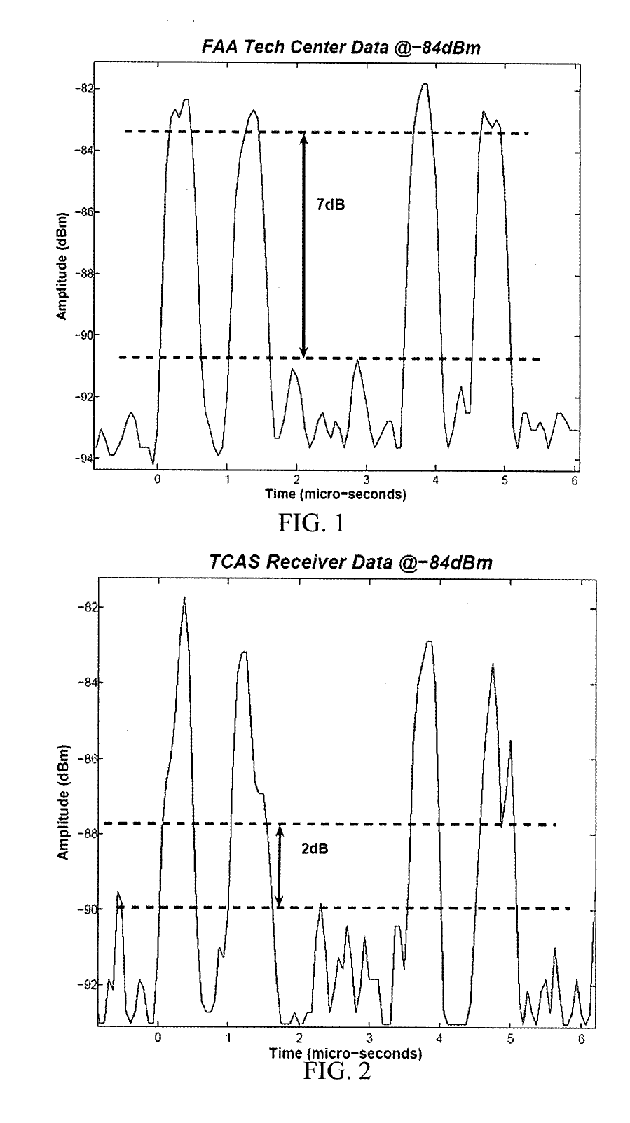

An embodiment of the invention uses the Baseline Multi-Sample Technique described in 1.4.2.3.1. The thresholds for determining the bit values and confidence levels is adjusted for a 16 MHz sample rate. The value used for the preamble reference level is the Ref_Level signal which is the output of the Matched Filter Preamble Preamble Timing Logic Block 415. The start of the decoding operation is triggered off of the clock sample where the Msg_Decode signal is a 1. If the Msg_Decode signal is set to 1 prior to the end of the message decoding operation, a preamble re-trigger has occurred and the processing will restart with the new timing and reference levels provided to the data block. After the 112 bit message is received and the bit value and bit confidence for the message is decoded, the Enhanced Error Detection and Correction Techniques described in DO-260A Appendix 1.4.3 will process the received data. The preferred embodiment of the invention uses the message processing flowchart in DO-260A Appendix I, FIG. 1-9. This includes the use of the Conservative Error Correction technique and Brute Force Error Correction techniques if the decoded message contains errors.

If the ADS-B/TIS-B message either has no errors, or was able to be corrected by either the Conservative Error Correction or Brute Force Error Correction techniques, the 112 bit message is sent to the Micro-Processor 380 for use in surveillance tracking algorithms. If the message was not able to be corrected it is discarded. An embodiment of the invention transfers the 112 bit message over a PCI bus into the Micro-Processor's 380 system memory.

FIG. 5 is a flowchart illustrating the Matched Filter Preamble Detection Logic 415. The first 7 decision blocks 500-530 check that the Matched Filter output for the 4 preamble pulses P(1) to P(4) along with the first 3 bits of the DF field DF(1) to DF(3) have levels which exceed the minimum RF level MF_Level signal. Note that DF(1) through DF(3) may be either a 1 or a 0, however since the ADS-B DF field is either DF-17 (10001) or DF-18 (10010), the samples are chosen assuming the value is 100. If any of these tests fail, the module sets 535 the MF_Pre(n) signal to a value of 0 and returns, which signifies that no valid preamble was detected.

The next 4 decision blocks 540, 545, 580, and 585 check the DF(4) and DF(5) samples for a valid RF levels assuming the ADS-B squitter is a DF-17 (01) or a TIS-B squitter is DF-18 (10). If the first 2 decision blocks 540, 545 indicate DF(4) and DF(5) have valid levels for a data pattern of 01, the 9 samples are sorted 550 assuming a DF-17 ADS-B squitter is decoded. Otherwise the DF(4) and DF(5) are tested for having valid levels for a data pattern of 10 by the next 2 decision blocks 580 and 585. If valid levels are detected for this pattern, then the 9 samples are sorted 590 assuming a DF-18 TIS-B squitter is decoded, otherwise the module sets 595 the MF_Pre(n) signal to a value of 0 and returns. Note that while the algorithm is defined to process 2 types of DF fields, the algorithm will support other DF fields with additional tests, or the modification of tests.

If either the DF-17 or DF-18 tests pass, the appropriate samples which were used in the previous decision blocks are sorted 550, 590 by magnitude from lowest to highest magnitude. The mean value is computed 555 from the 4 samples with the lowest amplitude. This value is assigned 555 to the signal MF_Pre(n), and is termed the Matched Filter reference level. Note that only the lowest samples are used in order to reduce the possibility of overlapping ATCRBS or Mode S interference pulses to corrupt the reference level determination.

A 1 micro-second test is performed 560 on the Matched Filter data samples similar to the method described in DO-260A Appendix 1.4.1.8. The minimum amplitude of MF samples (MIN) for the 1, 2, 4.5 and 5.5 micro-second positions [MF(n−184), MF(n−168), MF(n−128), MF(n−112)] are taken and compared to the maximum amplitude of MF samples (MAX) for the 0 and 3.5 micro-second positions [MF(n−200), MF(n−144)]. If MIN is 3 dB or higher than MAX, then the preamble is rejected and the module sets 595 the MF_Pre(n) signal to a value of 0 and returns.

A 3.5 micro-second test is performed 565 on the Matched Filter data samples similar to the method described in DO-260A Appendix 1.4.1.8. The minimum amplitude of MF samples (MIN) for the 3.5, 4.5, 7.0 and 8.0 micro-second positions [MF(n−144), MF(n−128), MF(n−88), MF(n−72)] are taken and compared to the maximum amplitude of MF samples (MAX) for the 0 and 1.0 micro-second positions [MF(n−200), MF(n−184)]. If MIN is 3 dB or higher than MAX, then the preamble is rejected and the module sets 595 the MF_Pre(n) signal to a value of 0 and returns.

A 4.5 micro-second test is performed 570 on the Matched Filter data samples similar to the method described in DO-260A Appendix 1.4.1.8. The minimum amplitude of MF samples (MIN) for the 4.5, 5.5, 8.0 and 9.0 micro-second positions [MF(n−128), MF(n−112), MF(n−72), MF(n−56)] are taken and compared to the maximum amplitude of MF samples (MAX) for the 0 1.0 and 3.5 micro-second positions [MF(n−200), MF(n−184), MF(n−144)]. If MIN is 3 dB or higher than MAX, then the preamble is rejected and the module sets 595 the MF_Pre(n) signal to a value of 0 and returns.

The next test checks 575 that each of the 4 preamble pulses [MF(n−200), MF(n−184), MF(n−144), MF(n−128)] are greater than the MF_Pre(n) amplitude determined previously minus a threshold value (MF_Pre(n)−Threshold). The threshold value used in the invention was 9 dB. If any of the preamble pulses fail this test then the preamble is rejected and the module sets 595 the MF_Pre(n) signal to a value of 0 and returns.

If all tests pass, the module exits, with the MF_Pre(n) signal value set to a non-zero value.

FIG. 6 is a flowchart illustrating the Matched Filter Preamble Timing Logic 420. The MF_Pre(n) and MF_Level signals are input and output to/from the Matched Filter Preamble Detection Logic Block 415, respectively. The MF_Pre(n) signal is non-zero to indicate a valid preamble has been detected for the current sample. The MF_Level signal sets the minimum RF level used for decoding a valid pulse, and provides for re-triggering for higher level decoded preambles. The Msg_Decode and Ref_Level signals are output to the DO-260A Data Decoding Logic Block 425. The Msg_Decode signal is asserted for one clock cycle, and indicates the start of the first bit of the 112 bit ADS-B/TIS-B Squitter Message which triggers the data decoding operation. The Ref_Level signal is the RF Reference Level which is used for the data decoding operation.

The Matched Filter Preamble Timing Logic Block 420 has signals which are initialized on system power-up or when re-initiating the operational mode for decoding ADS-B/TIS-B squitters. The Ref_Level and MF_Level signals are set to a value MF_MTL, which is the minimum triggering level for ADS-B squitters. For DO-260A Class A3 operations, MF_MTL would typically be set for around −88 dBm.

The first test checks 600 if the MF_Pre(n) is greater then the MF_Level_Max signal. If the test passes, the Pre_Count is initialized 605 to 8, and the MF_Level_Max is set 605 to the current MF_Pre(n) value. This is done to detect the peak of the preamble pulse correlation, which gives the best timing for the data decoding operation.

If the MF_Pre(n) test fails, then the value Pre_count is decremented 640 if greater than zero 635. If it equals zero after the decrement operation, then a valid preamble has been detected. The Msg_Decode signal will be set 650 to 1 which triggers the data detection algorithm in the DO-260A Data Decoding Logic Block 425. The Ref_Level will be set 650 to the MF_Level_Max which is the reference level of the preamble used by the same data decoding block. The MF_Level will be set 650 to the MF_Level_Max+a threshold value. The threshold value is typically set to 3 dB. This allows for the Matched Filter Preamble Detection Logic Block 415 to re-trigger on a higher level preamble. The Msg_count signal is set 650 to a value which is 112 micro-seconds multiplied by the number of A/D samples per micro-second rate (16 for Fs=16 MHz). This counter is used to reset signals to the default value after the data decoding has finished.

The Msg_Decode flag will be set 610 to 0 for any path other than when the preamble is detected. This insures that the signal is only set to a 1 for one clock cycle. The Msg_Count signal is decremented 620 if greater than zero 615. If it is zero after the operation 625, then the Ref_Level, MF_Level and MF_Level_max are set 630 to default values.

The foregoing description of the illustrated embodiments of the present invention is by way of example only, and other variations and modifications of the above-described embodiments and methods are possible in light of the foregoing teaching. For example, embodiments of this invention include using the matched filter for detecting the data in the ADS-B/TIS-B reply. This occurs after the preamble timing and reference level have been determined. Note that this method could be used with conventional DO-260A preamble detection techniques, or also with the matched filter preamble detection technique described in this invention. The matched filter output can be used in a similar manner as the multi-sample techniques described in Appendix I. The appendix I methods use individual samples for each bit. This invention would use the matched filter output for determining the bit value and confidence level. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method for processing ADS-B or TIS-B squitter signals, comprising:
receiving an ADS-B or TIS-B squitter signal;
converting the signal to a digital signal; and
matching at least a portion of the digital signal to a message using matched filters.

2. The method of claim 1, further comprising matching at least a portion of the digital signal to a preamble using matched filters.

3. The method of claim 2, wherein the message matching occurs if the preamble matching is successful.

4. The method of claim 1, wherein the matched filters are implemented in a time domain.

5. The method of claim 1, wherein the matched filters are implemented in a frequency domain.

6. The method of claim 1, further comprising receiving a plurality of ADS-B squitter signals from a directional antenna and selecting a signal have the highest magnitude for the converting.

7. A TCAS receiver, comprising:
an antenna for receiving an ADS-B or TIS-B squitter signal;
an analog to digital converter for converting the signal to a digital signal; and
a FPGA having matched filters for matching at least a portion of the digital signal to a message.

8. The receiver of claim 7, wherein the FPGA includes a matched filter preamble detection logic block for matching at least a portion of the digital signal to a preamble using matched filters.

9. The receiver of claim 8, wherein the message matching occurs if the preamble matching is successful.

10. The receiver of claim 7, wherein the matched filters are implemented in a time domain.

11. The receiver of claim 7, wherein the matched filters are implemented in a frequency domain.

12. The receiver of claim 7, wherein the antenna includes a directional antenna for receiving a plurality of ADS-B squitter signals and wherein the FPGA selects a signal have the highest magnitude for the converting.

13. A system for processing ADS-B or TIS-B squitter signals, comprising:
means for receiving an ADS-B or TIS-B squitter signal;
means for converting the signal to a digital signal; and
means for matching at least a portion of the digital signal to a message using matched filters.
